(19) United States
(12) Patent Application Publication
(10) Pub. No.: US 2010/0046872 A1
(43) Pub. Date: Feb. 25, 2010

(54) BEARING ASSEMBLY FOR A SPINDLE OF A MACHINE TOOL

(76) Inventors: Hiroshi Takiuchi, Mie (JP); Yasutsugu Tanaka, Mie (JP)

Correspondence Address: WENDEROTH, LIND & PONACK, L.L.P., 1030 15th Street, N.W.,, Suite 400 East, Washington, DC, 20005-1503, US

(21) Appl. No.: 12/515,580

(22) PCT Filed: Nov. 21, 2007
(86) PCT No.: PCT/JP2007/072524

§ 371 Date: May 20, 2009

(30) Foreign Application Priority Data
Nov. 28, 2006 (JP) 2006-320016

(51) Int. Cl. F16C 19/50

(52) U.S. Cl. 384/476

(57) ABSTRACT

The object is to reduce the temperature rise and thermal expansion of the angular ball bearing by releasing heat produced therein to the housing, while keeping its outer race loosely fitted in the housing.

By filling the gap between outer races 2a of combined angular ball bearings 2, which are loosely fitted in a housing 12, and the radially inner surface of the housing 12 with a heat conductive grease 3 containing inorganic powder as a heat conductive material, heat produced in the combined angular ball bearings 2 can be released from the outer races 2a to the housing 12 through the heat conductive grease 3. Thus, it is possible to reduce temperature rise and thermal expansion of the angular ball bearings 2, while keeping them loosely fitted in the housing.

This invention relates to a bearing assembly for supporting a front portion of a spindle of a machine tool.

### BACKGROUND ART

Known bearing assemblies for supporting a front portion of a machine tool spindle include ones comprising a front cylindrical roller bearing such as a double row cylindrical roller bearing and a rear angular ball bearing or bearings such as combined angular ball bearings (see e.g. Patent Publication 1). The outer race of the cylindrical roller bearing, which supports radial loads, is fitted tightly in the radially inner surface of the housing of the machine tool, while the outer race of the angular ball bearing, which supports thrust loads, is fitted relatively loosely in the radially inner surface of the housing.

Spindles of today's machine tools are operated at increasingly higher speeds. Many of today's machine tools include a built-in motor mounted between front and rear bearing assemblies supporting front and rear portions of the spindle, respectively. In order to release heat produced from the bearing assemblies and the motor, circular grooves or a helical groove is formed in the outer periphery of the housing through which e.g. cooling oil flows.
Patent document 1: JP Utility Model Publication 60-103725

### OBJECT OF THE INVENTION

In such a bearing assembly supporting a machine tool spindle, heat produced in the cylindrical roller bearing can be readily and efficiently released from its outer race to the housing because the outer race is tightly fitted in the housing. But heat produced in the angular ball bearing is less likely to be released to the housing because its outer race is loosely fitted in the housing. Thus, the angular ball bearing tends to be heated to higher temperature. Because this rear angular ball bearing is located adjacent to the built-in motor, which is another heat source, the inner temperature tends to rise more sharply. Such temperature rise may cause thermal expansion of the angular ball bearing, which may in turn lower the machining accuracy of the machine tool, thus making it difficult to increase the rotational speed of the spindle.

An object of the present invention is to reduce the temperature rise and thermal expansion of the angular ball bearing by releasing heat produced therein to the housing, while keeping its outer race loosely fitted in the housing.

### MEANS TO ACHIEVE THE OBJECT

In order to achieve this object, the present invention provides a bearing assembly for a spindle of a machine tool comprising a front cylindrical roller bearing and a rear angular ball bearing, wherein the spindle has a front portion thereof supported on a housing through the bearing assembly, the cylindrical roller bearing including an outer race tightly fitted in a radially inner surface of the housing, and the angular ball bearing including an outer race loosely fitted in the radially inner surface of the housing, characterized in that a gap defined between the outer race of the angular ball bearing and the radially inner surface of the housing is filled with a heat conductive liquid viscous substance containing a heat conductive material.

By filling the gap between the outer race of the angular ball bearing and the radially inner surface of the housing with the heat conductive liquid viscous substance containing a heat conductive material, heat produced in the angular ball bearing, which is loosely fitted in the housing of the machine tool spindle, can be released from the outer race to the housing through the heat conductive liquid viscous substance. Thus, it is possible to reduce temperature rise and thermal expansion of the angular ball bearing, while keeping its outer race loosely fitted in the housing.

The heat conductive material contained in the heat conductive liquid viscous substance may be inorganic powder such as graphite, alumina, silica, aluminum nitride, boron nitride or zinc oxide.

The heat conductive liquid viscous substance may be a heat conductive grease.

### ADVANTAGES OF THE INVENTION

In the bearing assembly for a machine tool spindle according to the present invention, since the gap between the outer race of the angular ball bearing and the radially inner surface of the housing is filled with the heat conductive liquid viscous substance containing a heat conductive material, heat produced in the angular ball bearing, which is loosely fitted in the housing of the machine tool spindle, can be released from the outer race to the housing through the heat conductive liquid viscous substance. Thus, it is possible to reduce temperature rise and thermal expansion of the angular ball bearing, while keeping its outer race loosely fitted in the housing. This in turn makes it possible to increase the rotational speed of the spindle while preventing deterioration in machining accuracy of the machine tool.

### BRIEF DESCRIPTION OF THE DRAWING

FIG. 1 is a vertical sectional view of a spindle of a machine tool in which a bearing assembly for a machine tool spindle according to the present invention is mounted.

### DESCRIPTION OF THE NUMERALS

1. Double row cylindrical roller bearing
2. Combined angular ball bearings
1a. 2a. Outer race
3. Heat conductive grease
11. Spindle
12. Housing
12a. Helical groove
13. Double row cylindrical roller bearing
14. Motor

### BEST MODE FOR EMBODYING THE INVENTION

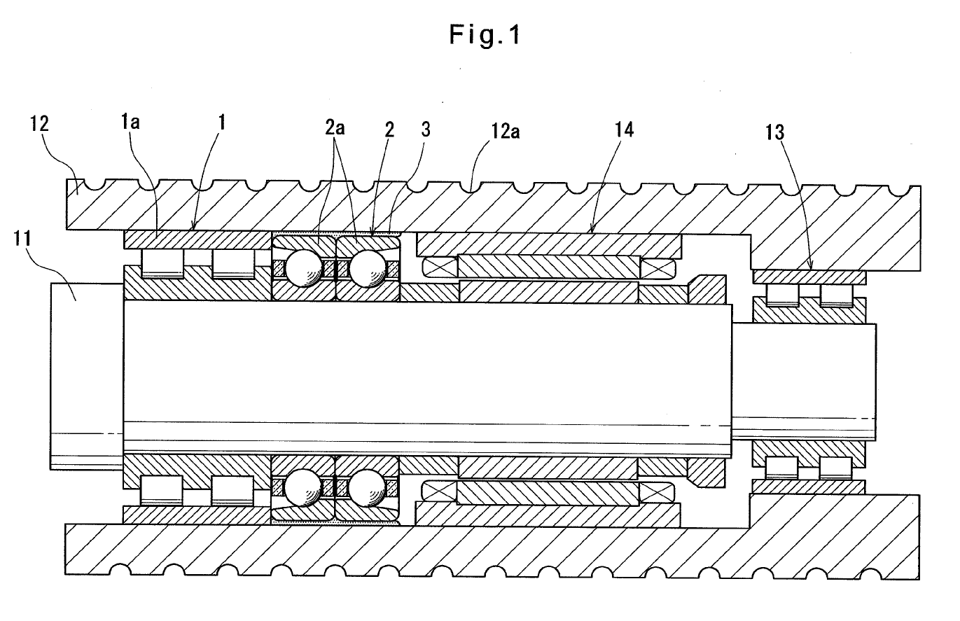

The embodiment of the present invention is now described with reference to FIG. 1, which shows a spindle 11 of a machine tool on which a bearing assembly for a spindle of a machine tool according to the present invention is mounted. The spindle 11 has its front portion supported by the radially inner surface of a housing 12 through a bearing assembly according to the present invention, which comprises a front multiple (double) row cylindrical roller bearing 1, and rear combined angular ball bearings 2, and has its rear portion supported by the radially inner surface of the housing through a double row cylindrical roller bearing 13. A motor 14 is mounted between these two supported portions. A helical groove 12a is formed in the outer periphery of the housing 12 through which cooling oil flows.

The front double row cylindrical roller bearing 1 at the front portion of the spindle supports radial loads, with its outer race 1a fitted tightly in the housing 12. The rear combined angular ball bearings 2 at the front portion of the spindle support thrust loads, with their outer races 2a loosely fitted in the housing 12. The gap between the outer races 2a and the radially inner surface of the housing 12 is filled with a heat conductive grease 3.

The heat conductive grease 3 comprises a viscous grease and 20 to 40% by mass of inorganic powder as a heat conductive material. The grease 3 is applied to the radially outer surfaces of the outer races 2a of the respective combined angular ball bearings 2 and the radially inner surface of the housing 12 before the bearings 2 are fitted in the housing 12 so that after the bearings 2 are fitted in the housing 12, the gap between the radially outer surfaces of the outer races and the radially inner surface of the housing is filled with the grease 13. Thus, the heat conductive grease 3 fills this gap with a high filling rate, thereby efficiently releasing heat produced in the combined angular ball bearings 2 from their outer races 2a to the radially inner surface of the housing 12.

What is claimed is:

1. A bearing assembly for a spindle of a machine tool comprising a front cylindrical roller bearing and a rear angular ball bearing, wherein the spindle has a front portion thereof supported on a housing through said bearing assembly, said cylindrical roller bearing including an outer race tightly fitted in a radially inner surface of the housing, and said angular ball bearing including an outer race loosely fitted in the radially inner surface of the housing, characterized in that a gap defined between the outer race of said angular ball bearing and the radially inner surface of the housing is filled with a heat conductive liquid viscous substance containing a heat conductive material.

2. The bearing assembly of claim 1 wherein said heat conductive liquid viscous substance is a heat conductive grease.
